(19) United States
(12) Patent Application Publication
(10) Pub. No.: US 2026/0092894 A1
(43) Pub. Date: Apr. 2, 2026

(54) Magnetic Yoke Assembly and Pipeline Inspection Equipment for Detecting Defects in Steel Pipelines

(71) Applicants: HUNG MINH VU, Ba Ria (VN); QUOC BINH MINH PHAN, Ba Ria (VN); QUANG HONG PHAM, Ba Ria (VN); KHUONG NGOC NGUYEN, Ba Ria (VN); VINH QUANG NGUYEN, Ba Ria (VN)

(72) Inventors: HUNG MINH VU, Ba Ria (VN); QUOC BINH MINH PHAN, Ba Ria (VN); QUANG HONG PHAM, Ba Ria (VN); KHUONG NGOC NGUYEN, Ba Ria (VN); VINH QUANG NGUYEN, Ba Ria (VN)

(73) Assignee: Petrovietnam, Ha Noi (VN)

(21) Appl. No.: 19/226,208

(22) Filed: Jun. 3, 2025

(30) Foreign Application Priority Data
Mar. 6, 2024 (VN) 1-2024-04031

(51) Int. Cl. G01N 27/90; F16L 55/40; F16L 101/30; G01N 27/9013

(52) U.S. Cl. CPC G01N 27/9006; F16L 55/40; G01N 27/902; F16L 2101/30

(57) ABSTRACT

The present invention discloses a magnetic yoke assembly for detecting defects in steel pipes. The magnetic yoke assembly includes an array of magnetic sensors and arrays of steel brushes coupled to Archimedes disc cam assembly. The array of magnetic sensors is supported by finger-shaped sensor arm frames that are flexibly designed, which can reduce the impact of collision with defects inside the pipe. Archimedes disc cam assembly functions to set the position of the array of magnetic sensors with respect to the inner walls of the pipes.

Please replace the original specification by the following substitute specification under 37 C.F.R. § 1.121(b)(3)(i). These amendments add no new matters since they only describe in words the details in the submitted FIGs and per the request by the Notice to File Corrected Application Papers dated Jun. 12, 2025.

### CLAIM OF PRIORITY

This patent application claims priority under 35 U.S.C. § 119 and 37 C.F.R. § 1.55 of a foreign patent application No. 1-2024-04031, entitled, “Cum Gông Tù′ và Thi\hat{è}t Bi Kháo Sát Ðu′ò′ng \vec{a}\hat{é} Phát Hi\hat{é}n Khuy\hat{é}t Tât trong Ðu′ò′ng Óng Thép Gao G\hat{ò}m Cum Gông Tù′ Này″—by Hung Minh Vu, Quoc Binh Minh Phan, Quang Hong Pham, Khuong Ngoc Nguyen, and Vinh Quang Nguyen, filed on Jun. 3, 2024 in Socialist Republic of Vietnam, which is incorporated by reference in its entirety.

### FIELD OF THE INVENTION

The present invention relates to a pipeline inspection gadget (PIG). More particularly, this invention relates to a method and apparatus for a magnetic yoke assembly for pipeline inspection gadget (PIG).

### BACKGROUND OF THE INVENTION

Nowadays, oil and gas are energy and raw materials that play a very important role in the development of agriculture, industry and national security. It is well known that pipeline systems are the most effective and safest method in transporting oil and gas. However, pipelines are very susceptible to many factors such as geology, flow, temperature, pressure, corrosion, collision, etc. A small leak in the pipeline can also cause huge consequences not only related to the environment but also economic losses.

Currently, the problems inside the pipeline are hydrates and solidified paraffin, rust corrosion, and scale, which are the causes of transportation obstruction; especially for undersea pipelines. Therefore, the pipeline must be cleaned periodically, depending on the quality of the product running inside. The cleaning periods must be scheduled are 3 months/time, 6 months/time, 1 year/time; 2 years/time, 3-5 years/time.

The scheduled cleaning period shall promptly detect defects in gas pipelines. Non-destructive testing methods (NDT) are often used such as radiographic testing (RT), ultrasonic testing (UT), liquid penetrant testing (PT), magnetic particle testing (MT), eddy current testing (ET), magnetic flux leakage testing (MFL). Among these, only ultrasonic, eddy current or flux leakage methods can be used for buried or submerged pipelines.

Among the three methods above, the magnetic flux leakage detection (MFL) method is the most popular because it inherently has following advantages: no need for complicated pre-processing, easy signal acquisition, easy online measurement. In addition, it can detect many types of defects such as surface defects, voids, scars, cracks, corrosion. In addition, the MFL method can detect defects both inside and outside the pipe walls.

The essence of this method is a device called PIG (Pipeline Inspection Gauge-PIG) equipped with magnetic sensors designed to clean and inspect the pipe. This device is inserted into and move along the pipe under the pressure of gas or liquid pressure. During the movement of the PIG along the pipe, the signals received from the magnetic sensors will be converted into voltage (V or mV) and saved to the data acquisition unit (Data Acquisition). Depending on the dimension of the pipe and the size of the PIG, the number of sensors may vary.

The data collected from PIG is about 10 Gb of data per 100 km of surveyed pipeline. Normally, processing this large volume of data takes a longtime and depends [[a lot]] on data analysis skills. Therefore, a challenge for the pipeline maintenance process is to build an automated process that increases the accuracy of the results as well as reduces the latency.

The signals obtained from the sensors are not always accurate. This is caused by noise generated by the eddy currents during the movement of the PIG, by corroded materials, or by deposits. There are many noise filters that can be used to solve this problem, including: Practical filter, Kalman filter, Adaptive practical filter. However, noises are naturally not fixed, it requires the filter to automatically change the parameters for each type of noise to preserve the received signals. In addition, the delay time and oscillation amplitude are also criteria to be considered for these filters.

Vietnam is managing about 3,700 km of gas pipelines, including the Cuu Long Basin Gas Pipeline System, the Nam Con Son Pipeline System, the Phu My-Nhon Trach Pipeline System, the Phu My-My Xuan-Go Dau Low Pressure Gas Pipeline System, and the PM3-Ca Mau Gas Pipeline System. To maintain effective operations and avoid incidents, these gas pipeline system must be regularly maintained and serviced. These services include cleaning the pipelines and detecting cracks and deformations. To complete these tasks, oil and gas companies often have to hire a pipeline survey equipment called PIG to clean out deposits, detect deformation. Although the demand for PIG is large, research on PIG in Vietnam mainly comes from PVU with some related research projects as a premise [1-7].

With the above operating principle of the magnetic flux leakage (MFL) method, the ability to detect defects depends greatly on the angle between the direction of the defect and the direction of the magnetizing magnetic field. Therefore, the MFL technology defect detection equipment is divided into two types: horizontal defect detection type and vertical defect detection type.

The two types of transverse (vertical) and longitudinal (horizontal) flaw detectors differ mainly in the direction of magnetization. With transverse flaws, the direction of magnetization is along the length of the pipe. With longitudinal flaws, the direction of magnetization is circumferential perpendicular to the length of the pipe. Along with the direction of magnetization, the sensor array is spatially arranged so that the entire circumference of the pipe are scanned by at least one sensor. while the technology for transverse PIGs is quite complete, longitudinal flaws still face many difficulties because magnetization in the circumferential direction is much more difficult than in the longitudinal direction of the pipe.

Factors that ensure a good operation of an MFL type PIG device include:

A mechanical system that assists the device to move easily, smoothly, stably, and at a controllable speed inside the pipe.

A magnetization system that ensures a saturated magnetization state without the need of a power source (i.e., a permanent magnet must be used).

A system of magnetic sensors with high sensitivity, stability, durability, water resistance, pressure resistance, good noise reduction, and scanning all positions along the pipe circumference and especially must have low power consumption to ensure long-term continuous operation in the pipeline.

A system of data collection, storage, processing with high speed, large flow, suitable algorithm, clear and convenient display interface.

A large capacity battery system ensures the device operates for many hours.

The process of mastering PIG technology raises many issues that need to be researched. First of all, there are basic studies on measurement principles, factors affecting measurement results, optimal configurations, and data processing algorithms. Next are studies aimed at designing and improving technical issues related to the ability to detect defects and collect and process results at high speed and large capacity. Finally, there are studies related to PIG motion control, wireless signal collection, and interpretation of results. These studies are carried out on test sites or in the field of pipeline systems.

As mentioned above, the biggest challenge for a defect detection PIG is the ability to detect defects, the heart of which lies in the magnetic sensor system. It is the combination of sensors whose characteristics meet special requirements. This requires a mechanical system that brings the sensor close to the pipe wall. At the same time, it must also be safe from impacts, high pressure, flooding, and dirt. Other characteristics of the sensor are high sensitivity, stability and especially low energy consumption.

Currently, the sensors used in PIGs of companies around the world are conventional Hall sensors. The sensitivity of this type of sensor meets the required level of sensitivity, but its main limitation is its high power consumption, which limits the continuous operating time. In addition, to complete the ability to detect defects, the device also needs to integrate a high-speed data collection, storage, processing system, large flow, suitable algorithms, and a clear and convenient display interface.

The sensors used in pipeline inspection gadgets (PIGs) provided by the present invention meets the above requirements.

### SUMMARY OF THE INVENTION

An object of the invention is to provide a magnetic yoke assembly for use in a pipeline inspection gadget (PIG) including a cam mechanism designed to control the position of the magnetic yokes relative to the wall of the pipe to be surveyed; the cam mechanism helps setting the most suitable distance between the magnetic sensor and the pipe wall; this suitable distance measures and collects magnetic flux leakage signals (MFL) while preventing the magnetic sensor from being damaged due to untoward collision with the pipe's inner wall deposits. This magnetic yoke assembly includes a flexible sensor arm mechanism equipped with Hall or flat Hall type sensors, thereby stabilizing the sensors and softening the impact of collision with floating defects inside the pipe.

Another object of the invention is to provide a pipeline survey device for detecting defects in steel pipelines including a flexible sensor arm mechanism coupled to a cam mechanism. This device can be moved along in a pipeline inspection gadget (PIG) by a lead screw and two high-precision and stable reels.

Another object of the present invention is to provide a magnetic yoke assembly designed to detect defects in steel pipelines, the magnetic yoke assembly including: magnetic yokes; an Archimedes cam mechanism for arranging and controlling the position of the magnetic yokes relative to the wall of the steel pipe to be inspected. The Archimedes cam mechanism is preset at a suitable distance sufficient to measure the magnetic flux leakage signal (MFL) and safe from collision with the pipe's wall deposits; each of the magnetic yokes including two steel brushes, a sensor mounting system for mounting the magnetic sensors, and a magnetic yoke mounting board for arranging the steel brushes and the sensor mounting system thereon; the steel brushes comprise a conductive steel brush and a magnet; the sensor mounting system comprises a finger shaped sensor assembly; and a camshaft mechanism includes a first spiral groove camshaft, a second spiral groove camshaft, a servo motor and the centering tube for arranging the first spiral groove camshaft relative to the second spiral groove camshaft on the center tube; the first spiral groove camshaft and the second spiral groove camshaft are driven by the servo motor.

Another object of the present invention is to provide the magnetic yoke further includes a sensor assembly mounting plate and a magnetic steel frame.

Another object of the present invention is to provide the steel brushes, the sensor mounting system, the sensor assembly mounting plate, and the magnetic steel frame are arranged on the magnetic yoke mounting boards.

Another object of the present invention is to provide the sensor mounting system is arranged above and connected to the magnetic steel frame by means of the sensor assembly mounting plate; and the steel brushes are arranged at both ends and connected to the magnetic steel frame;

Another objective of the present invention is to provide the sensor mounting system includes a finger sensor assembly including four parallelogram mechanical fingers.

### BRIEF DESCRIPTION OF THE DRAWINGS

FIG. 1 shows a magnetic yoke assembly for use in a pipeline inspection gadget (PIG) in accordance with an exemplary embodiment of the present invention;

FIG. 2 shows the two dimensional (2D) internal structure of the magnetic yoke assembly in accordance with an exemplary embodiment of the present invention-;

FIG. 3 shows the two dimensional (2D) components of a single magnetic yoke mounting board of the magnetic yoke assembly—in accordance with an exemplary embodiment of the present invention;

FIG. 4 shows the top view structure and components of a single magnetic yoke mounting board in accordance with an exemplary embodiment of the present invention;

FIG. 5 shows a side view of the finger-shaped magnetic sensor mounting frame in accordance with an exemplary embodiment of the present invention;

FIG. 6 shows a lateral view of the magnetic brush container designed to contain magnets in accordance with an exemplary embodiment of the present invention;

FIG. 7 shows the 3D overall view of an Archimedes cam disc assembly with a servo motor in accordance with an exemplary embodiment of the present invention;

FIG. 8 shows the 2D cross section of the Archimedes cam disc assembly and the servo motor in accordance with an exemplary embodiment of the present invention;

FIG. 9 shows the 2D top view of the Archimedes cam disc assembly in accordance with an exemplary embodiment of the present invention;

FIG. 10 shows the direct front view of the Archimedes cam disc assembly in accordance with an exemplary embodiment of the present invention;

FIG. 11 shows the front view of an Archimedes straight groove disc of the Archimedes cam disc mechanism in accordance with an exemplary embodiment of the present invention;

FIG. 12 shows he front view of an Archimedes counterclockwise-spiral-grooves disc in accordance with an exemplary embodiment of the present invention;

FIG. 13 shows the front view of an Archimedes clockwise-spiral-groove disc in accordance with an exemplary embodiment of the present invention;

FIG. 14 shows the attachment plates secured to the Archimedes cam disc assembly for mounting magnetic yoke mounting boards in accordance with an exemplary embodiment of the present invention;

FIG. 15A-FIG. 15B shows an Archimedes cam disc coupling device in accordance with an exemplary embodiment of the present invention;

FIG. 16 shows the 2D schematic diagram of an pipeline inspection gadget (PIG) for detecting defects in steel pipes in accordance with an exemplary embodiment of the present invention;

FIG. 17 shows 2D detail diagram of another pipeline inspection gadget (PIG) in accordance with an exemplary embodiment of the present invention, in which:

FIG. 18 shows the schematic diagram of a front section of a pipeline inspection gadget (PIG) including the magnetic yoke assembly in accordance with an exemplary embodiment of the present invention;

FIG. 19 shows the superior view of the front section PIG equipment in accordance with an exemplary embodiment of the present invention;

FIG. 20 shows the rear section of the pipeline inspection gadget (PIG) in accordance with an exemplary embodiment of the present invention;

FIG. 21 shows the front view of the rear buffer block of rear section without encoders of the PIG equipment head in accordance with an exemplary embodiment of the present invention;

FIG. 22 shows the structure of the front cable coupling assembly of the PIG in accordance with an exemplary embodiment of the present invention;

FIG. 23A-FIG. 2B show the structure of the front encoder wheel assembly of the PIG in accordance with an exemplary embodiment of the present invention;

FIG. 24A-FIG. 24B show the structure of the rear encoders wheel assembly of the PIG device in accordance with an exemplary embodiment of the present invention;

FIG. 25 shows the cardan joint assembly in accordance with an exemplary embodiment of the present invention;

FIG. 26 shows the front view of the Y-shaped wheel connector assembly in accordance with an exemplary embodiment of the present invention in detail;

FIG. 27 shows the rear buffer blocks of the rear section of the PIG in accordance with an exemplary embodiment of the present invention;

FIG. 28 shows a front cardan joint wheel assembly in accordance with an exemplary embodiment of the present invention;

FIG. 29 shows a rear cardan joint wheel-assembly in accordance with an exemplary embodiment of the present invention; and

FIG. 30 shows the rear cable connector assembly in accordance with an exemplary embodiment of the present invention.

### DETAILED DESCRIPTION OF THE INVENTION

Hereinafter, the invention will be described in detail through specific embodiments with reference to drawings.

It should be noted that the drawings are considered to be the most intuitive means of illustration for a person skilled in the art and therefore constitute an integral part of this description. Accordingly, the proposed invention provides a phrase for a pipeline surveying device and a pipeline surveying device for detecting defects in steel pipelines including the phrase as described in the drawings. Furthermore, to the extent that any part of the description may be considered insufficiently illustrated, the drawings enable a person skilled in the art to carry out and describe the invention to the fullest extent.

In addition, it should be noted that some drawings may have different sizes and scales for the purpose of enlarging, clarifying the parts, details, means of connection, interactions between the related mechanism assemblies. However, the same parts, details, means of connection, interactions are shown with the same number of instructions to facilitate understanding of the invention.

The subject matter of the present invention is described in more details below.

### Magnetic Yoke Assembly

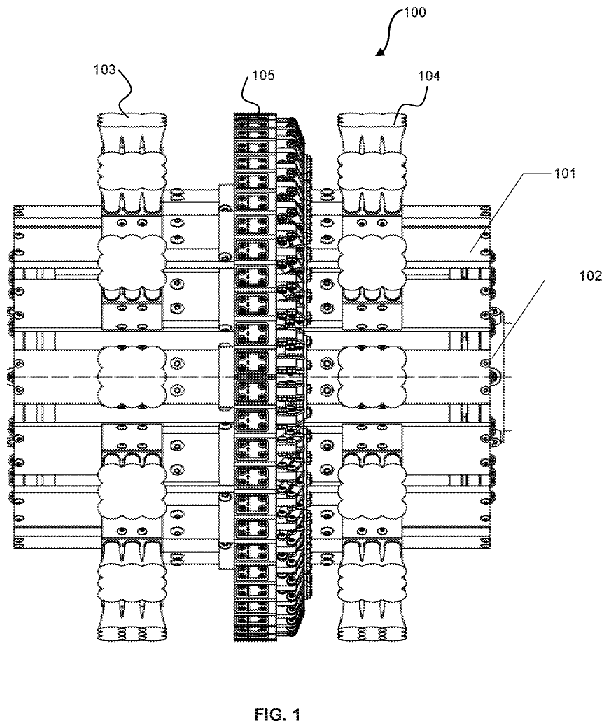

As shown in FIG. 1, magnetic yoke assembly 100 for detecting defects in steel pipelines in accordance with an exemplary embodiment of the present invention is illustrated.

Magnetic yoke assembly 100 includes:
magnetic yoke mounting boards (plates or planks) 101 arranged around the inner perimeter of a pipe;
an Archimedes cam disc assembly 102 designed to control the position of an array of magnetic sensors 105 relative to the steel pipe wall. The position of array of magnetic sensors 105 is preset at a suitable value sufficient to (a) measure the magnetic flux leakage signal (MFL) and (b) alleviate the impact between array of magnetic sensors 105 and pipe wall's hard deposits. A first set of steel brushes 103 is arranged one side of array of magnetic sensors 105. A second set of steel brush 104 is arranged on the other side of array of magnetic sensors 105. Both first set and second set of steel brushes 103 and 104 are designed to clean up the pipe wall off deposits. This arrangement helps cleaning up any pipe wall's hard deposits that could (a) slow the flow of fluid in the pipe and (b) damage array of magnetic sensors 105.

In many preferred embodiments of the present invention, Archimedes cam disc assembly 102 is an “Archimedes cam mechanism”. Archimedes cam assembly 102 is a mechanism formed by the combination of differently structured Archimedes spiral grooves. Archimedes cam disc assembly 102 is a specialized mechanical device for generating a reciprocating motion on the output disc link thanks due to the geometrical shape of the input disc. The input discs operate as a cam (CAM), and the output disc operates as a lever that presets the position of each magnetic sensors 105. In addition, Archimedes spiral grooves cause Archimedes-shaped motion trajectory that presets the precise position of array of magnetic sensors 105.

A servo motor 106 positioned in a space inside magnetic yoke mounting boards 101 designed to drive Archimedes cam disc assembly 102 which in turn drives array of magnetic sensors 105 to a preselected position.

In operation, magnetic yoke assembly 100 according to the present invention includes magnetic yoke mounting boards 101 coupled to Archimedes cam disc assembly 102. Archimedes cam disc assembly 102 is driven by servo motor 106 and functions to preset the distance between array of magnetic sensors 105 and the pipe wall to a predetermined value. This predetermined distance is optimal to measure the strongest magnetic flux lines (MFL) signals generated by first set of steal brushes 103 and second set of steel brushes 104 that are reflected from the pipe walls, while avoiding unwanted friction with the pipe wall friction. First set of steel brushes 103 and second set of steel brushes 104 are operable to clean up deposits on the pipe walls.

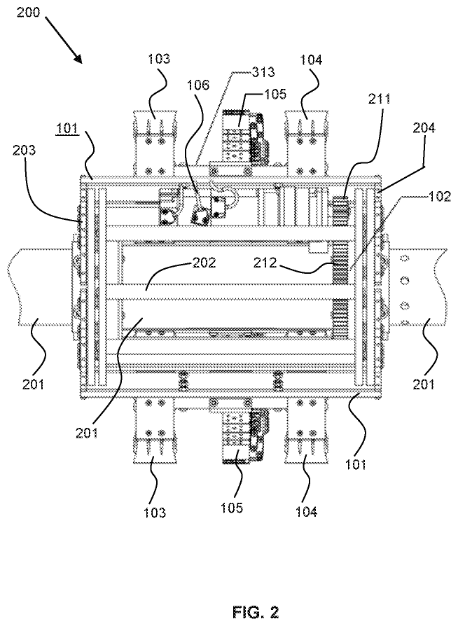

FIG. 2 to FIG. 30 provide detailed description and comprehensive arrangements of magnetic yoke assembly 100 and the pipe magnetic gadget (PIG) of the present invention.

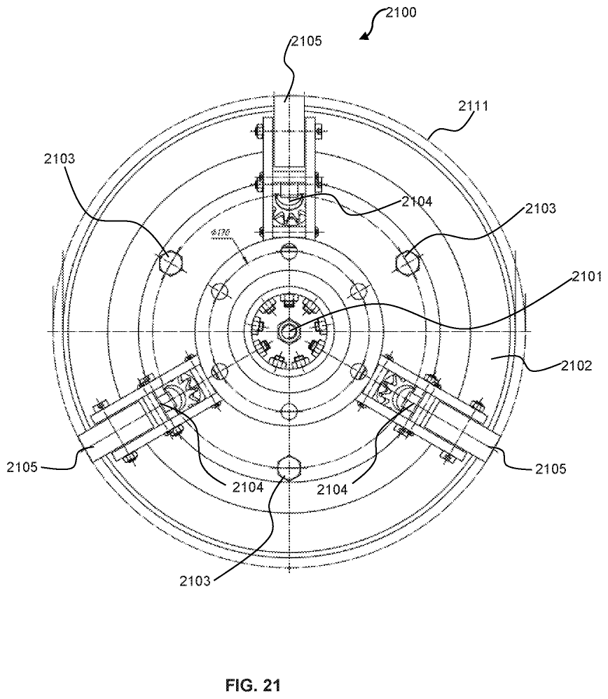

Now referring to FIG. 2, a 2D internal structure 200 of magnetic yoke assembly in accordance with an exemplary embodiment of the present invention is illustrated. In FIG. 2, most of magnetic yoke mounting boards 101 are removed to show the internal structure of magnetic yoke assembly 100. Magnetic yoke mounting boards 101 are arranged around a center axis 201 and coupled to Archimedes cam disc assembly 102. Archimedes cam disc assembly 102 includes a first mounting disc 203 and a second mounting disc 204. It will be disclosed later that first mounting disc 203 and second mounting disc 204 are Archimedes spiral grooves cam discs equipped with attachment plates. See FIG. 21. Protective tubes 202 connect first mounting disc 203 and second mounting disc 204, which are parts of Archimedes cam disc assembly 102. Magnetic yoke mounting boards 101 are mounted on first mounting disc 203 and second mounting disc 204. The inner space between first attachment disc 203 and second attachment disc 204 is where servo motor 106 is positioned. Next, servo motor 106 is coupled to a spur gear that includes a driving gear 211 and a driven gear (pinion) 212. Both driving gear 211 and driven gear 212 are coupled to rotate Archimedes cam disc assembly 102.

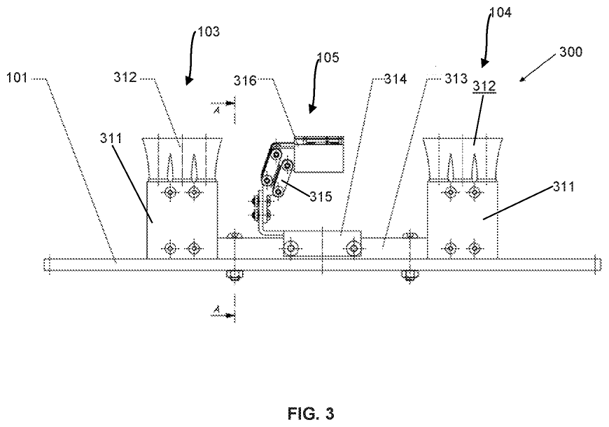

Referring next to FIG. 3, a schematic diagram of a single magnetic yoke mounting board 300 and its magnetic components in accordance with an exemplary embodiment of the present invention is illustrated. each of the magnetic yoke mounting board 300 includes a magnetic steel brush mounting base 311, magnetic steel brushes 312, a magnetic sensor mounting base 313 secured to magnetic yoke mounting board 300, a magnetic sensor foot 314 for coupling to magnetic sensor mounting base 313, a finger-shaped magnetic sensor frame 315 for supporting a magnetic sensor container (box) 316. Magnetic steel brush mounting base 311 supports magnetic steel brushes 312. Magnetic sensor mounting base 313 supports both magnetic sensor foot 314 and finger-shaped magnetic sensor frame 315 thereon. According many embodiments of to the present invention, each magnetic yoke mounting board 101 includes 2 magnetic steel brushes 312 positioning on both sides to protect magnetic sensor containers (boxes) 316 and their magnet contents.

Continuing with FIG. 3, magnetic yoke mounting board 300 includes magnetic sensor foot 314 and a magnetic finger-shaped magnetic sensor frame 315. As shown, according to the present invention, magnetic steel brushes 312, magnetic sensor mounting base 313, magnetic sensor-foot 314, and the magnetic finger-shaped magnetic sensor frame 315 are arranged on magnetic yoke mounting boards 101. Specifically, finger-shaped magnetic sensor-frame 315 is arranged above and connected to magnetic sensor mounting base 313 by the magnetic sensor foot 314. Magnetic steel brushes 312 are arranged at both ends and connected to the magnetic sensor containers 316.

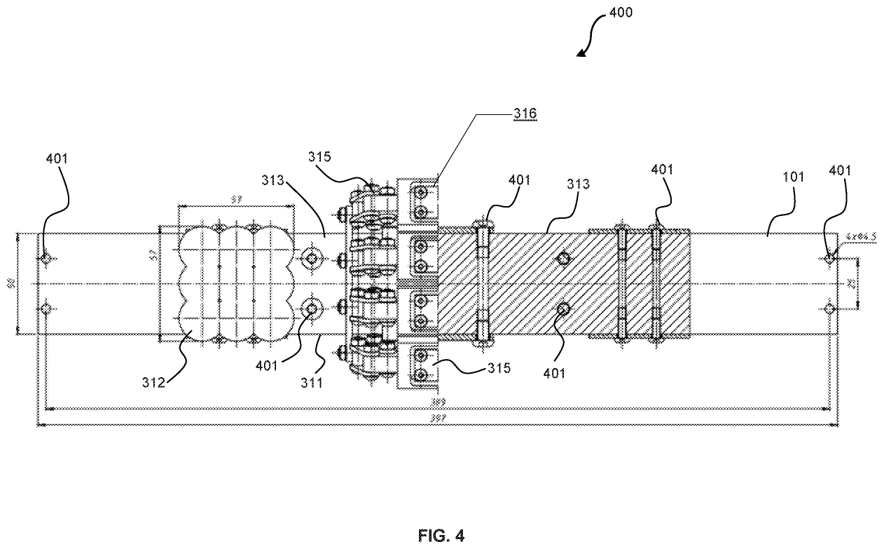

Referring next to FIG. 4, a top down view diagram 400 of the magnetic yoke mounting board in accordance with an exemplary embodiment of the present invention is illustrated. Magnetic yoke mounting board 101 is a rectangular trip of metal with securing screws 401. On the left hand side of magnetic yoke mounting board 101, magnetic steel brush 312 is mounted on magnetic brush mounting base 311 by securing screws 401. As discussed before, magnetic brush mounting base 311 is an integral extension of magnetic sensor mounting base 313. On the right hand side of finger-shaped magnetic sensor frame 315, magnetic brush mounting base 311 and magnetic steel brush 312 are removed to show that magnetic sensor mounting base 313 is attached to magnetic yoke mounting boards 101 by securing screws 401.

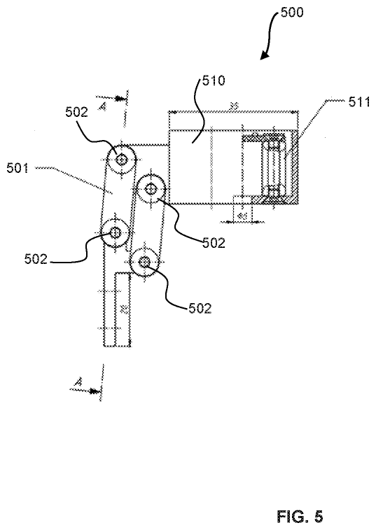

Referring now to FIG. 5, a side view diagram of the magnetic sensor assembly 500 in accordance with an exemplary embodiment of the present invention is illustrated. Finger-shaped magnetic sensor mounting frame 315 is a flexible finger shaped device which includes a magnetic sensor box 510 mounted on an elongate and finger-shaped magnetic sensor frame 501. Elongate and flexible finger-shaped magnetic sensor frame 501 is flexible because of rotatable screws 502. Each magnetic sensor box 510 has three separate chambers 511 which allow the arrangement and installation of 3 magnetic sensors. Thus, magnetic sensor assembly 500 allows for the arrangement and installation of 12 magnetic sensors. However, the present invention is not limited to this particular embodiment and therefore magnetic sensor box 510 can be arranged and installed with any suitable desired number of sensors. This structure of magnetic sensor assembly 500 according to the invention is designed such that the sensors can be installed close to the pipelines without undue vibrations and harmful collisions.

Continuing with FIG. 5, magnetic sensors are sensors that convert the strength and variation of magnetic fields into electrical signals. Magnetic sensors may have different operating principles based on different effects such as magnetic induction effect, Hall effect, giant magnetoresistance (GMR), anisotropic magnetoresistance (AM) principle, Josephson effect and other physical phenomena.

In many preferred embodiments of the present invention, the magnetic sensors used in the present invention are Hall type or planar Hall type sensors for the purpose of detecting magnetic changes caused by the defects in the pipelines.

The Classic Hall Sensor (CHS) is a type of sensor that operates based on the principle of the Hall effect that is used to measure the magnitude of a magnetic field. Its output voltage is proportional to the magnetic field strength perpendicular to the sensor surface.

The Planar Hall Sensor (PHS) operates on the principle of Anisotropic Magnetoresistance (AMR). Its output voltage is proportional to the magnetic field strength parallel to the sensor surface. The basic characteristics of these types of sensors are shown in the following table.

In many preferred embodiments of the present invention, a flat Hall sensor is used due to its many outstanding advantages in terms of sensitivity, energy saving, and temperature stability. Table 1 below summarizes the properties comparisons between the planar Hall sensors and other normal.

TABLE 1
Properties of Planar Hall Magnetic Sensors versus Normal Sensors

| | Normal Hall | | Planar Hall | |
|---|---|---|---|---|
| Operating Principles | Hall Effect | | Irregular Magnetic | |
| | | | effect AMR | |
| Magnetic Direction | 900 to the induced | | Parallel to the induced | |
| | plane | | plane | |
| Sensitivity | 3-5 | mV/Gauss | 100-1000 | mV/Gauss |
| Measured Length | No limit | | Elongated, <100 Gauss | |
| Temperature Drift | Large even with | | Insignificant | |
| | compensation | | | |
| Electricity Consumption | 1 | W | 10⁻³ | W |

| | | |
|---|---|---|
| Costs | Low, popular | High, not popular |

It is noted that sensors of the present invention can be obtained from many commercially available sources, so the detailed descriptions of these sensors are not necessary.

In addition, it should be noted that certain parts, details, means of connection, connections and their dimensions constituting magnetic yoke assembly 100 and other accompanying apparatuses described in more detail below may be omitted from the detailed description because (a) they are specifically illustrated in the drawings, and (b) they facilitate the understanding of the invention.

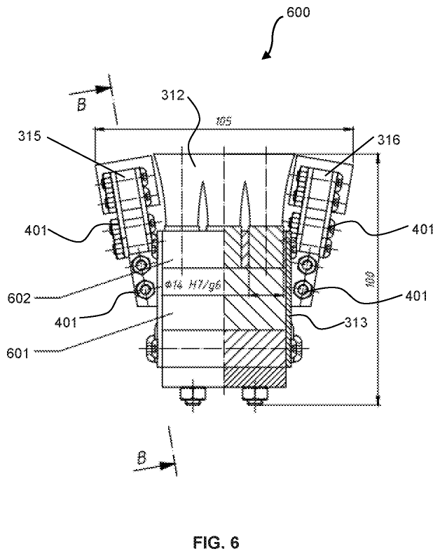

Referring to FIG. 6, a diagram 600 showing a side view of magnetic steel brush container in accordance with an exemplary embodiment of the present invention is illustrated. Side view diagram 600 shows that magnetic sensor containers 316 appeared on both sides of steel brush mounting base 601. At the center, steel brush mounting base 601 with securing screws 401 is shown. Steel brush mounting base 601 includes magnets 602 coupled to magnetic steel brushes 312. The magnets selected for use in magnets 602 are preferably super-strong magnets. These types of magnets can generate very strong magnetic fields. In some preferred embodiments, the magnet the present invention is NdFeB N45. Following are the properties of the NdFeBN45 magnets used as magnets 601:

They have good resistance to demagnetization, their magnetism remains strong for a very long time.

They have the ability to retain a strong magnetic field after the magnetizing force disappears. Their residual magnetism after magnetization is very strong.

They can generate enormous magnetic force in a small space. Their magnetic strength and size ratio is very high.

They can withstand high temperatures up to 200° C. Their magnetism remains stable even when heated.

They have excellent resistance to corrosion and rusts.

This type of magnet (NdFeB N45) can be purchased from a commercially available source.

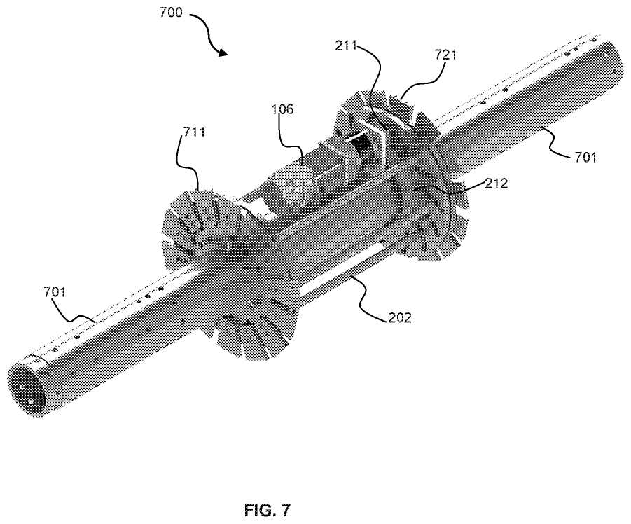

Now referring to FIG. 7, an overall view of a 32-mm Archimedes cam disc mechanism 700 in accordance with an exemplary embodiment of the present invention is illustrated. It can be seen that this cam mechanism includes a center tube 701 on and around the tube body are arranged two spiral grooved cam discs: a first attachment cam disc 711 and a second attachment cam disc 712. Protective tubes 202 connect first attachment cam disc 711 and second attachment cam disc 712 together. Servo motor 106 is connected to a driving gear 211 and a driven gear 212. When servo motor 106 is actuated, it causes driving gear 211 to rotate, which causes driven gear 212 to rotate that moves second attachment cam disc 712 to generate Archimedes motions that sets the distance between array of magnetic sensors 105 (see FIG. 3) and the pipeline's inner wall.

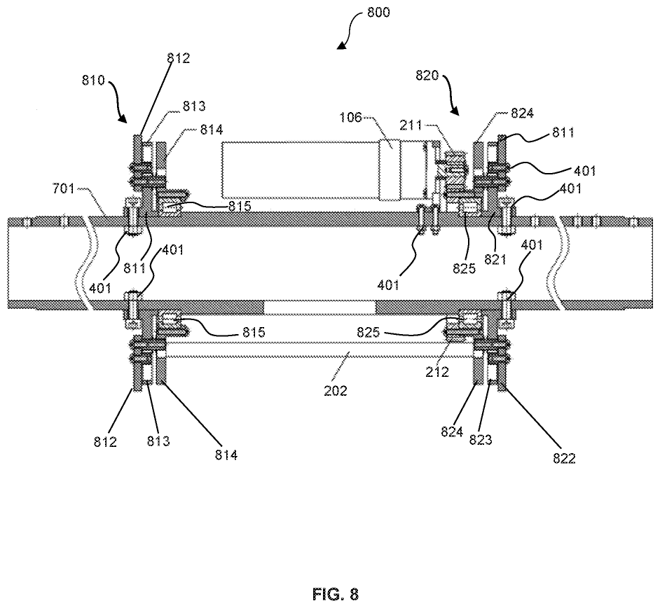

Referring next to FIG. 8, a 2D perspective diagram of Archimedes cam disc clamps 800 in accordance with an exemplary embodiment of the present invention is illustrated. Archimedes cam disc clamps 800 are a securing device that mounts and secures Archimedes cam disc assembly 102, servo motor 106, and spur gear (driving gear and driven gear) 211-212 to center tube 701 by securing screws 401. Archimedes cam disc clamps 800 include a first clamp set 810 and a second clamp set 820. First clamp set 810 includes a first clamp base 811 and a first reinforcement clamp 815 designed to secure a first set of Archimedes cam discs 812,813, and 814 to center tube 701 by securing screws 401. Second clamp set 820 includes a second clamp base 821 and a second reinforcement clamp base 825 designed to secure a second set of Archimedes discs 822,823, and 824 to center tube 701 by securing screws 401. Servo motor 106 is secured to driving gear (pinion gear) 211 which is meshed with driven gear 212. Servo motor 106 is protected by array of protective tubes 202. Array of protective tubes 202 connects disc Archimedes cam disc 814 and Archimedes cam disc 824 (see FIG. 7).

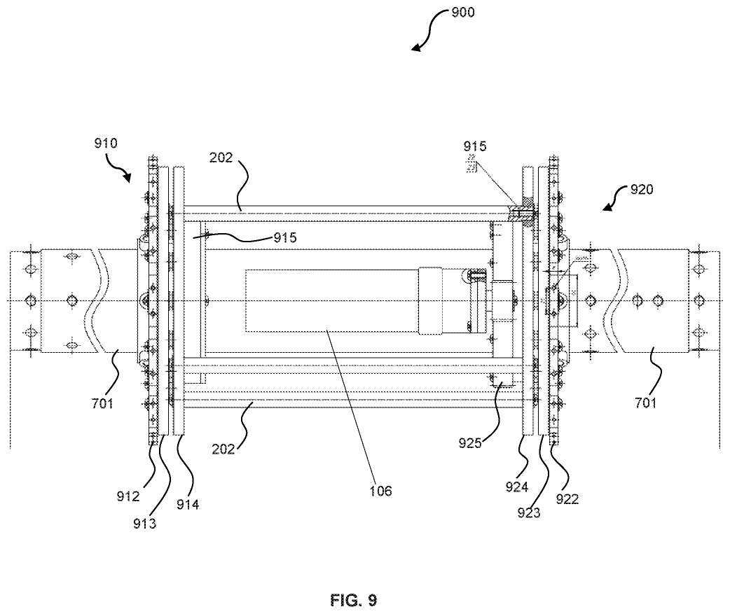

Now referring now to FIG. 9, a top view 900 of the same Archimedes cam disc mechanism in accordance with an exemplary embodiment of the present invention is illustrated. In FIG. 8, first clamp set 810 secures first set of Archimedes cam discs 812, 813, and 814 to center tube 701. Second clamp set 820 secures second set of Archimedes cam discs 822,823, and 824. Now in FIG. 9, first set of Archimedes cam discs 812-814 is designated as a front Archimedes cam disc assembly 910. Front Archimedes cam disc assembly 910 includes a first front helical groove cam disc 912, a second front straight groove cam disc 913, and a third front helical groove cam disc 914. Second set of Archimedes cam discs 822-824 is designated as a rear Archimedes cam disc assembly 920. Rear Archimedes cam disc assembly 920 includes a rear helical groove cam disc 922, a second rear straight groove cam disc 923, and a third rear helical groove cam disc 924. Rear Archimedes cam disc assembly 920 is attached to and directly driven by servo motor 106.

Continuing with FIG. 9, front Archimedes cam disc assembly 910 and rear Archimedes cam disc assembly 920 are coupled together by array of protective tubes 202, both are driven by servo motor 106. In addition, array of protective tubes 202 fixes the distance between front Archimedes cam disc assembly 910 and rear Archimedes cam disc assembly 920. This way, servo motor 106 is positioned inside the inner space formed by array of protective tubes 202. With this arrangement, servo motor 106 is hidden and protected by array of protective tubes 202. As disclosed in FIG. 7, servo motor 106 directly drives rear Archimedes cam disc assembly 920 by means of spur gears including respective driving and driven gears 211-212. A first reinforcement clamp 915 cushions and tightens first clamp base 811 and front Archimedes cam disc mechanism 910 onto center pipe 701 by securing screws 401. A second reinforcement clamp base 925 cushions and tightens second pipe clamp base 821 and rear Archimedes camshaft assembly 920 onto center pipe 701 by securing screws 401.

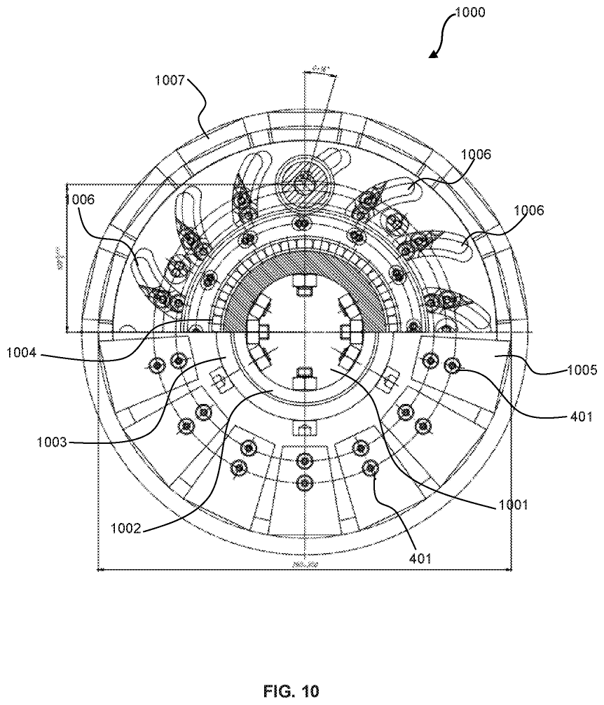

Now referring to FIG. 10, a front view 1000 of Archimedes cam disc mechanism in accordance with an exemplary embodiment is illustrated. The center of center pipe 701 is hollow area 1001. Concentric rims 1002, 1003, and 1004 of first rear helical groove cam disc 922, second rear straight groove cam disc 923, and third rear helical groove cam disc 924. Front view 1000 shows a series of clockwise spiral Archimedes grooves 1006 are formed on concentric rims 1003 and 1004. Attachment plates 1005 are connected to third rear helical groove cam disc 924 by a pair of securing screws 401. Each attachment plate 1005 are used to mount magnetic yoke mounting boards 101. It is noted that the same descriptions are applicable to first front helical groove cam disc 912, second front straight groove cam disc 913, and third front helical groove cam disc 914. Front view 1000 also shows an outer rim 1007. Outer rim 1007 is the exterior rim of magnetic yoke assembly 100.

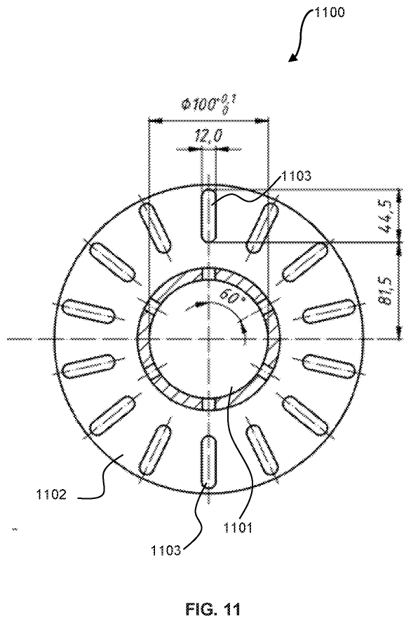

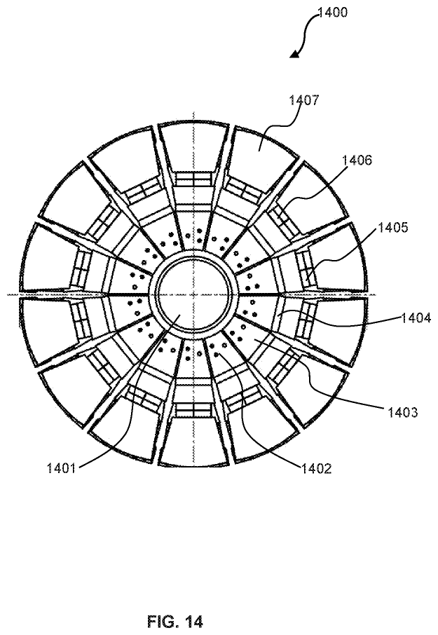

Now referring to FIG. 11, a two dimension (2D) view of an Archimedes straight groove cam disc 1100 for securing attachment plates in accordance with exemplary embodiment of the present invention is illustrated. Archimedes straight groove cam disc 1100 includes a center through hole 1101 at the center. A circular rim 1102 on which a series of straight grooves 1103 are formed. In the present invention, there are 14 Archimedes straight grooves 1103 arranged on circular rim 1102 at 30° next to one another. Attachment plates 1005 with screw holes are lined up with Archimedes straight grooves 1103 and securing screws 401 are inserted to secure attachment plate to protective disc as shown in FIG. 10 and FIG. 14.

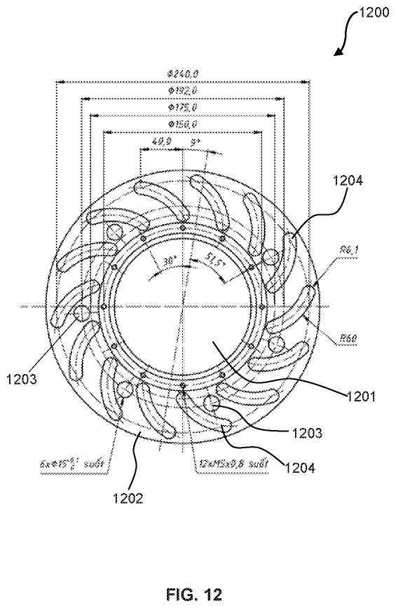

Referring now to FIG. 12, a 2D front diagram of an Archimedes counter clockwise helical groove cam disc 1200 in accordance with an exemplary embodiment of the present invention is illustrated. Archimedes counter clockwise helical groove cam disc 1200 has a center through hole 1201 at the center concentric with the hollow space of center pipe 701. A series of Archimedes counterclockwise spiral grooves 1204 is formed on a rim 1202. Next to some of Archimedes counterclockwise spiral grooves 1204 are screw holes 1203 for securing to protective tubes 202 that connect front Archimedes cam disc assembly 910 and rear Archimedes cam disc assembly 920 together.

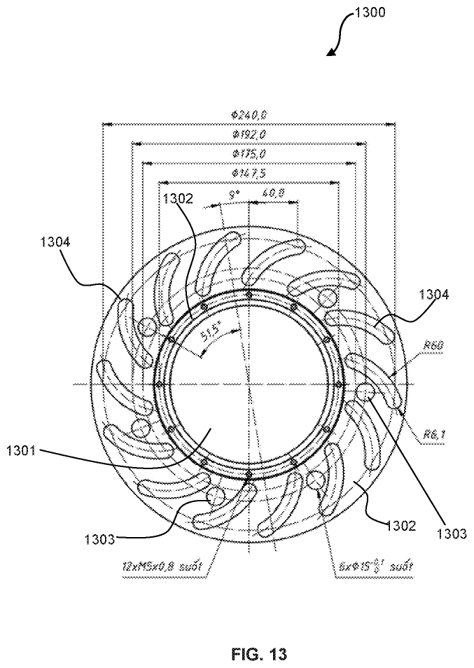

Similarly, referring next to FIG. 13, a 2D front view of an Archimedes clockwise groove cam disc in accordance with an exemplary embodiment of the present invention is illustrated. Third rear helical groove cam disc 1300 has a center through hole 1301 at the center concentric with the hollow space of pipe 701. A series of Archimedes clockwise spiral grooves 1304 is formed on a rim 1302. Next to some of clockwise grooves 1304 are screw holes 1303 for coupling to protective bars 202 that connect front Archimedes cam disc mechanism 910 rear Archimedes cam disc mechanism 920. See FIG. 9.

Next, referring to FIG. 14, a 2D front view diagram of a protective disc 1400 after attachment plate have been secured to front and rear helical groove cam discs in accordance with an exemplary embodiment of the present invention is illustrated. A center through hole 1401 is shown that is concentric with the hollow space of center tube 701. Fourteen attachment plates 1407 are secured to Archimedes straight grooves 1103 of respective front Archimedes cam disc mechanism 910 rear Archimedes cam disc mechanism 920. Each attachment plate 1407 includes a first segment 1402 with holes 1403, a gap 1404, an outer segment 1405, a flexible segment 1406, and second attachment cam disc 712. As described before, attachment plates 1407 are used to attach protective bars 202 between Archimedes front cam disc assembly 910 and rear Archimedes cam disc assembly 920.

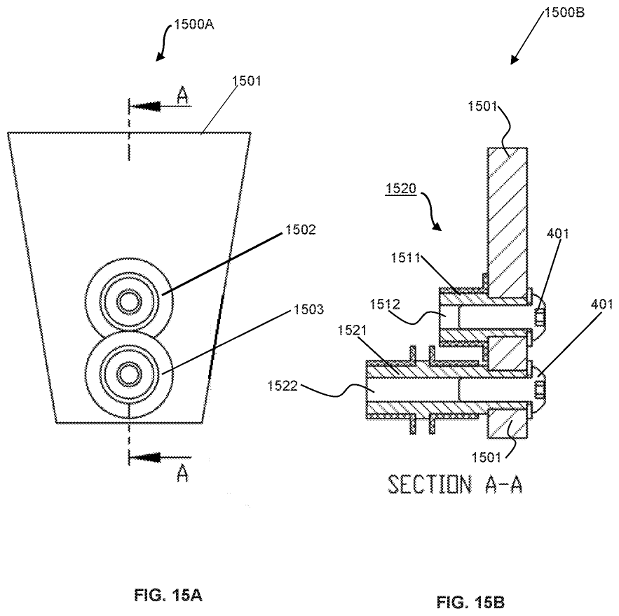

Next referring to FIG. 15A-FIG. 15B, different views 1500A-1500B of the attachment plates and Archimedes cam disc coupling device in accordance with an exemplary embodiment of the present invention is illustrated. More particularly, a front view 1500A of attachment plate 1501 is shown. Attachment plate 1501 is attached to Archimedes straight grooves 1103 (see FIG. 10) by securing screws 401 and bearings 1502 and 1503 respectively. In FIG. 15B, a cutaway side view AA′ 1500B of an Archimedes cam disc coupling device 1520 is shown. Attachment plate 1501 is inserted through a top bracket 1511 with a screw hole 1512 designated for securing screw 401. Attachment plate 1501 is also inserted to a bottom bracket 1521 with a through hole 1522 designed for securing screw 401. Archimedes cam disc coupling device 1500 functions to secure front Archimedes cam disc assembly 910 and rear Archimedes cam disc assembly 920 onto center axis 701.

### Pipeline Inspection Gadget (Pig)

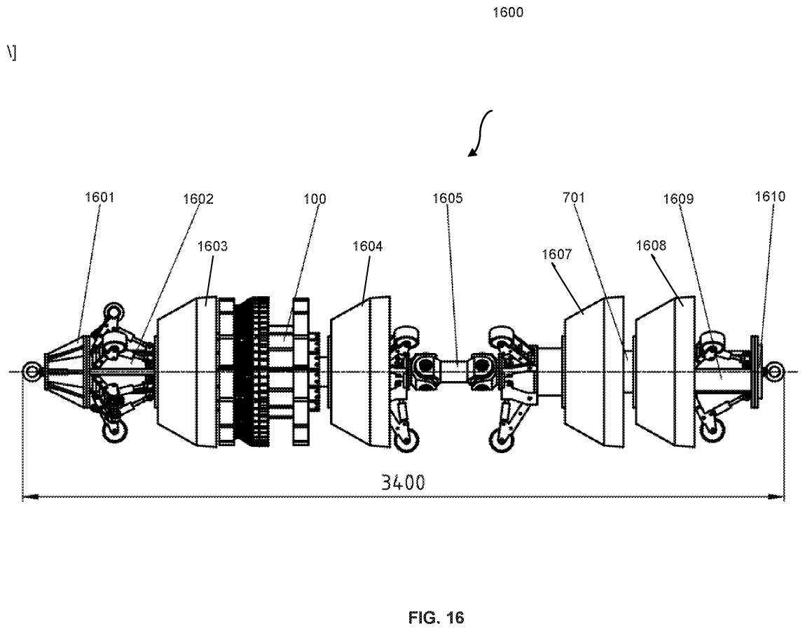

Referring to FIG. 16, 2D schematic diagram of the entire pipeline survey equipment also known as pipeline inspection gadget 1600 (PIG 1600) for detecting defects in steel pipes in accordance with an exemplary embodiment of the present invention is illustrated. A front cable coupling assembly 1601 is attached to a front wheel assembly 1602. Magnetic yoke assembly 100 is protected by front buffer blocks 1603-1604. Front buffer block 1604 is connected to a cardan joint 1605. The second terminal of cardan joint 1605 is connected to rear buffer blocks 1607-1608. A rear wheel assembly 1609 is coupled to a rear cable coupling assembly 1610. Front buffer blocks 1603-1604 and rear buffer blocks 1607-1608 have center openings that center tube 701 is inserted there through.

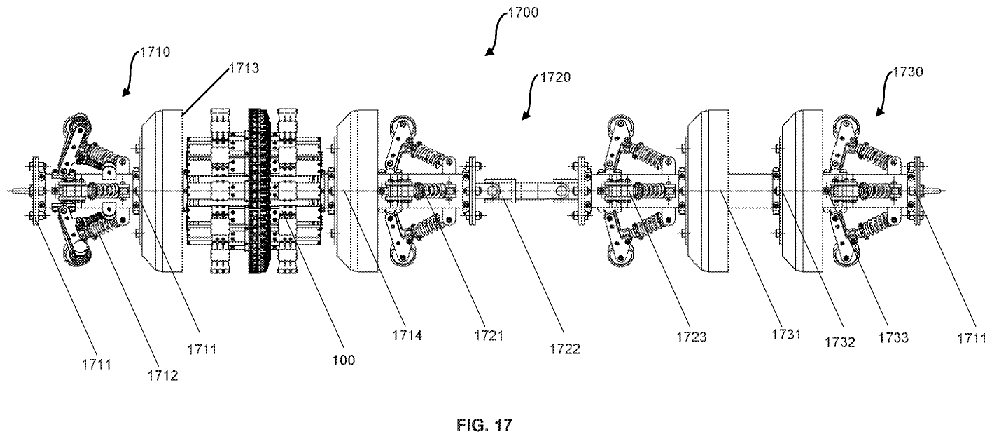

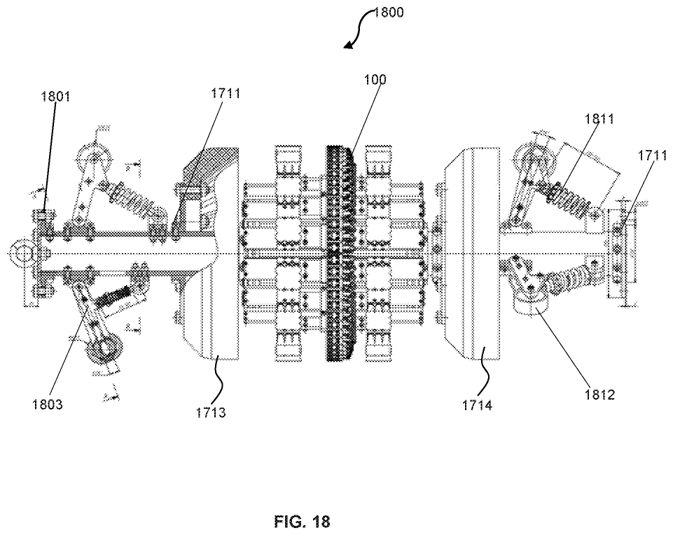

Referring to FIG. 17, a 2D detail diagram of another design of pipeline inspection gadget (PIG) 1700 in accordance with another exemplary embodiment of the present invention is illustrated. Pipeline inspection gadget (PIG) 1700 includes three principal sections: a front section 1710, a cardan joint section 1720, and a rear section 1730. Front section 1710 includes a front cable coupling assembly 1601 (not shown in FIG. 17, see FIG. 16) that is connected to a front wheel assembly 1712 by a ball bearing connector 1711. Ball bearing connector 1711 that connects front wheel assembly 1712 to a first front buffer block 1713. First front buffer block 1713 is then connected to the front end of magnetic yoke assembly 100 of the present invention. The back end of magnetic yoke assembly 100 is connected to second front buffer block 1714 by ball bearing connector 1711. Cardan joint section 1720 includes a front cardan joint wheel assembly 1721, a cardan joint 1722, and a rear cardan joint wheel assembly 1723. The back of second front buffer block 1714 is connected to front cardan joint wheel assembly 1720 and to a cardan joint 1722. Rear section 1730 includes a pair of rear buffer blocks 1731-1732, a rear wheel assembly 1733, and a rear cable connector (not shown, see FIG. 18). The other end of cardan joint 1722 is connected to a rear cardan joint wheel assembly 1723. A pair of rear buffer blocks 1731 and 1732 is used to maintain the center of gravity of magnetic yoke assembly 100. The end of pair of rear buffer blocks 1731-1732 is connected to rear wheel assembly 1733. Finally, rear wheel assembly 1733 is connected to a rear cable coupling assembly 1734.

Referring next to FIG. 18, a schematic diagram of a front section 1800 of the pipeline inspection gadget (PIG) in accordance with an exemplary embodiment of the present invention is illustrated. Front section 1800 is the same as front section 1710. In FIG. 18, front section 1800 shows a front wheel assembly 1803 including wheels 1803, a magnetic yoke assembly 100, and a front cardan joint wheel assembly 1811 (belongs to cardan joint section 1720) including wheels 1812. Front wheel assembly 1803 and front cardan joint wheel assembly 1811 have wheels that facilitate the movement of magnetic yoke assembly 100 inside the pipe being inspected. The structure and operation of magnetic yoke assembly 100 have been described in detailed above. Front wheel assembly 1803 and front cardan joint wheel assembly 1811 will be described later. First front buffer block 1713 and second front buffer block 1714 have various functions: (1) they separate and protect magnetic yoke assembly 100 from first wheel assembly 1803 and front cardan joint wheel assembly 1811 (2) they stabilize the movements of pipeline inspection gadget 1700 inside the pipeline under inspection. Front wheel assembly 1803 is connected to first front buffer block 1713 by a ball bearing connector 1711; similarly, magnetic yoke assembly 100 is connected to second front buffer block 1714 by ball bearing connector 1711.

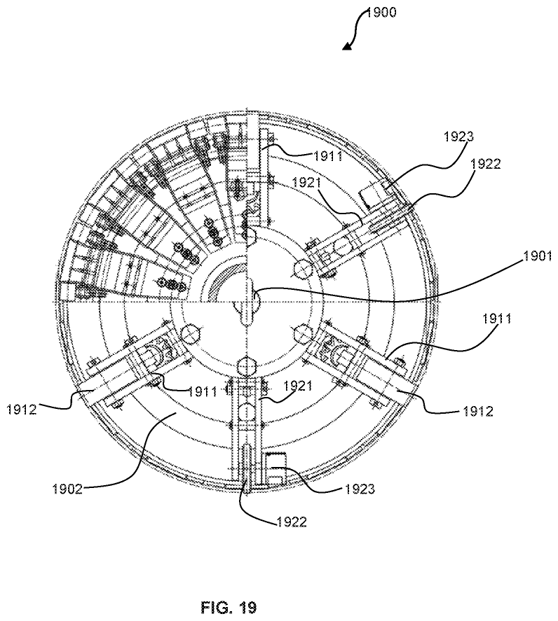

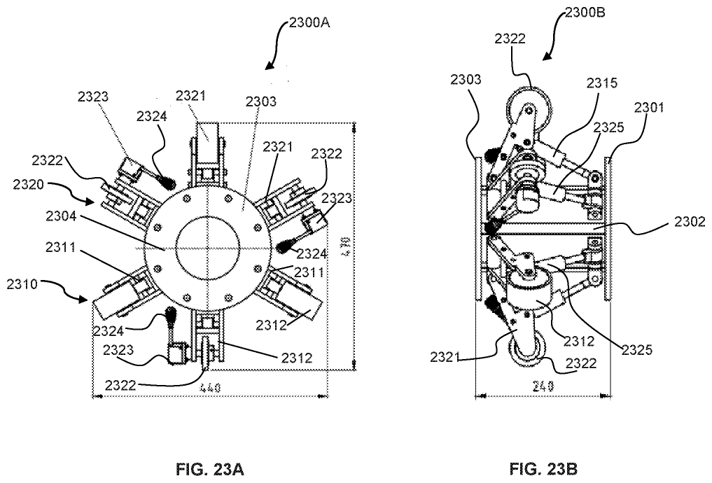

Continuing with FIG. 18, front wheel assembly 1803 is an encoder assembly or a displacement measuring assembly. Front wheel assembly 1803 functions to measure the displacement of PIG 1700 in the test pipeline through the encoders. The encoder is capable of converting the movement of the PIG 1700 into a digital signals or pulses which can be read on the microcontroller (not shown). See FIG. 19 and FIG. 23.

Referring to FIG. 19, a front view perspective of a front section 1900 of the PIG equipment in accordance with an exemplary embodiment of the present invention is illustrated. In FIG. 19, front section 1900 shows mainly first front buffer block 1713 together with front wheel assembly 1803, which shows a center tube 1901, a solid rim area 1902, wheel frames 1911, caster wheels 1912, encoder frame 1921, and encoder wheels 1922 with encoder 1923. In many embodiments of the present invention, caster wheels 1912 are used in both front wheel assembly 1803 and front cardan joint wheel assembly 1811. Encoders 1923 functions to record the position of magnetic yoke assembly 100 and the entire PIG 1700. Encoder 1923, also known as the displacement measuring assembly, functions to measure the displacement of PIG 1700 and magnetic yoke assembly 100. Each encoders 1923 is capable of converting the movements of encoder wheels 1922 and thus PIG 1700 into a digital signals or pulses which can be read by the microcontroller (not shown). The operations of encoders 1923 are well known in the arts and need not be described herewith. Encoders 1923 are arranged at 120° intervals around center tube 1901. Each encoder 1923 also is coupled to encoder wheel 1922 mounted on the center tube 1901. Encoder wheels 1922 are arranged at 120° intervals around the center tube 1901. As shown in FIG. 19, three encoder wheels 1922 and three caster wheels 1912 are arranged alternately at 60° intervals around the center tube 1901.

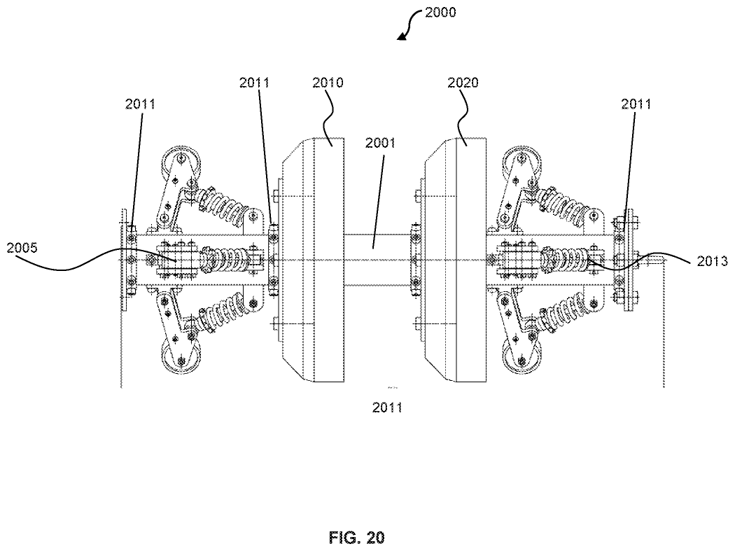

Referring now to FIG. 20, a rear section 2000 of the pipeline inspection gadget equipment (PIG equipment) in accordance with an exemplary embodiment of the present invention is illustrated. Rear section 2000 is the same as rear section 1730. Rear section 2000 of PIG 1700 includes a center tube (axle) 2001, a first rear buffer block 2010, and a second rear buffer block 2020 connected together as shown and described in FIG. 17 and FIG. 20. First rear buffer block 2010 is connected to second cardan joint wheel assembly 2005 while second rear buffer block 2020 is connected to rear wheel assembly 2013. First rear buffer block 2010 and rear wheel assembly 2013 are described later. These components of rear section 2000 are connected together by ball bearing connectors 2011 (the same as ball bearing connectors 1711).

Referring now to FIG. 21, a front view perspective of a rear buffer block of rear section without encoders 2100 of the PIG in accordance with an exemplary embodiment of the present invention is illustrated. Front buffer block with caster wheels 2100 has a center pipe 2101, a rim 2102, and screw holes 2103. Caster wheels 2105 that connects to front buffer block 2100 are seen in this front view. Wheel frame 2104 that supports caster wheel 2105 will be described later in FIG. 23-FIG. 25. Screw holes 2103 are used to connect first front buffer block 2010, center tube 2001, second rear buffer block 2020 together. The front view shows an outer rim 2111 since buffer block 2100 has a cut-away conic shape.

Wheels frames 2104 are designed to support the weight of PIG device 1700. Each wheel frames 2104 includes an axle 2106 and caster wheel 2105. Three wheel frames 2104 are arranged at 120-degree intervals around the center tube 2101.

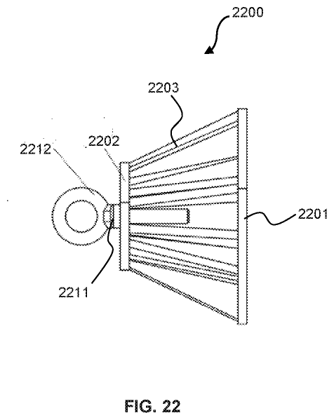

Referring to FIG. 22, a side view of a front cable coupling assembly 2200 of the pipeline inspection gadget (PIG) in accordance with an exemplary embodiment of the present invention is illustrated. Front cable coupling assembly 2200 has a cut-away conic shape that includes a first base 2201, a second base 2202, frames 2203, and a bolt connector 2211 that secures a cable ring 2212 to second base 2202. Front cable coupling assembly 2200 functions to connect the pipeline inspection device 1700 to a pulling cable or a moving motor.

Referring to FIG. 23A-FIG. 23B, structural diagrams 2300A-2300B of an encoder wheel assembly of the PIG device in accordance with an exemplary embodiment of the present invention are illustrated. More particularly, in FIG. 23A, a diagram 2300A shows a front view of encoder wheel assembly 2300 including a center circular section 2304 surrounded by caster wheel assemblies 2310 coupled to encoder devices 2320. Each caster wheel assembly 2310 are supported by a caster wheel frame 2311 and a caster wheel 2312. Encoder device 2320 includes an encoder support frame 2321, an encoder wheel 2322, and an encoder 2323. FIG. 23B shows a side view 2300B of encoder wheel assembly 2300. From side view diagram 2300B, a rear base 2301 and a front base 2303 are connected by a center axis 2302. Encoder support frames 2321 are arranged around center circular section 2304 and center axis 2302. Encoder device 2320 includes an encoder 2323 and is arranged at 120° (120 degrees) intervals around the center axis 2302.

For support of PIG 1700, the encoder wheel assembly 2300 has 3 caster wheel assemblies 2310 mounted around center axis 2302 and arranged at 120° intervals with respect to one another. Encoder devices 2320 and the caster wheel assemblies 2310 are arranged alternately at 60° intervals around the center axis 2302. Caster wheel assemblies 2310 function to support and move PIG 1700 along the pipeline while encode devices 2320 function to keep track and record PIG 1700 position.

According to some specific embodiments of the present invention, each encoder device 2320 includes encoder support frame 2321 for supporting an encoder box 2323 above and around center axis 2302. An absorption member 2325 designed to protect PIG 1700 when entering a pipeline areas with non-uniform surface topology. Each encoder device 2320 also includes an encoder handle 2324, an encoder wheel 2322 to mount encoder box 2323. Encoder 2323 is coupled to encoder wheel 2322 to measure the displacement of PIG 1700 in the pipeline, and wherein the encoder 2322 is coupled to the encoder wheel 2322. Absorption member 2325 each includes a spring. Springs function to absorb shocks caused by the impact of unwanted collisions or uneven surfaces of the pipeline.

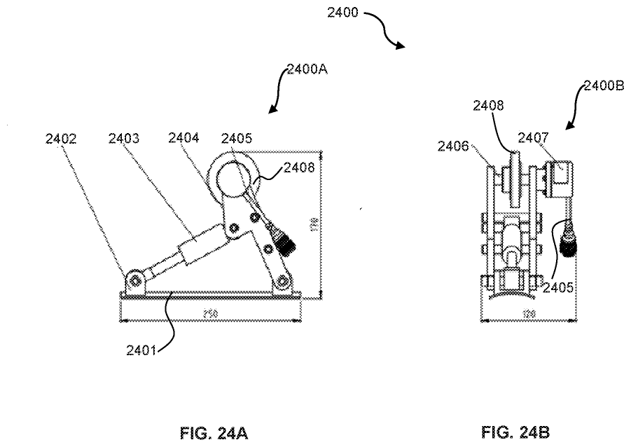

Referring to FIG. 24A-FIG. 24B, various views 2400A-2400B of a structure of wheel frame 2400 with encoders of the PIG device in accordance with an exemplary embodiment of the present invention is illustrated. More particularly, in FIG. 24A, a side view 2400A of a wheel frame 2400 is shown. Wheel frame 2400 includes a base 2401 upon which a bracket 2404 and a shock absorber 2403 are secured by rotatable screws 2402. As shown in a front view 2400B of FIG. 24B, a wheel axle (shaft) 2406 is attached to an encoder 2407 and a handle 2405. Encoder 2407 measures the distance between a wheel 2408 and the pipeline wall. Handle 2405 adjusts the distance by compressing or releasing shock absorber 2403. In many embodiments of the present invention, shock absorber 2403 is a spring.

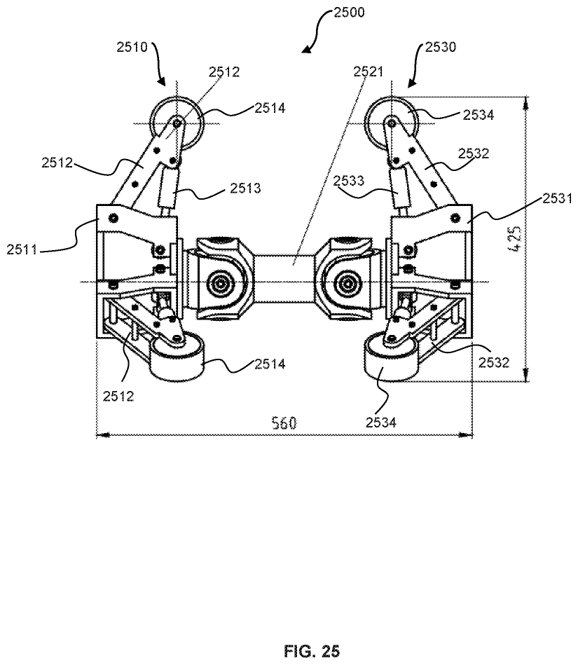

Referring to FIG. 25, a side view of a cardan joint section 2500 in accordance with an exemplary embodiment of the present invention are illustrated. Cardan joint section 2500 is the same as cardan joint section 1720. Cardan joint section 2500 is flexible that enables PIG 1700 to bend along the curvatures of the pipelines. Cardan joint section 2500 includes a first Y-shaped wheel support assembly 2510 connected to one end of a flexible cardan joint 2521 which, in turn, connects to a second Y-shaped wheel support assembly 2530. First Y-shaped wheel support assembly 2510 includes a first central bracket 2511 where first leg frames 2512 radiate out in a Y-shaped arrangement. First leg frames 2512 are connected to a first shock absorber 2513. The terminal end of first leg frame 2512 is connected to a first caster wheel 2514. Similarly, second Y-shaped wheel support assembly 2530 includes a second central bracket 2531 where second leg frames 2532 radiates out in a Y-shaped arrangement. Second leg frames 2532 is connected to a second shock absorber 2533. The terminal end of second leg frame 2532 is connected to a second caster wheel 2534. Cardan joint 2521 serves to connect front section 1800 to rear section 2000. Please refer back to FIG. 18 and FIG. 20. The cardan joint 2521 has two degrees of freedom to enable PIG 1700 to move flexibly and two intermediate first Y-shaped wheel support assembly 2510 and second Y-shaped wheel support assembly 2530 mounted on both sides of the cardan joint 2521 to support the load of PIG 1700.

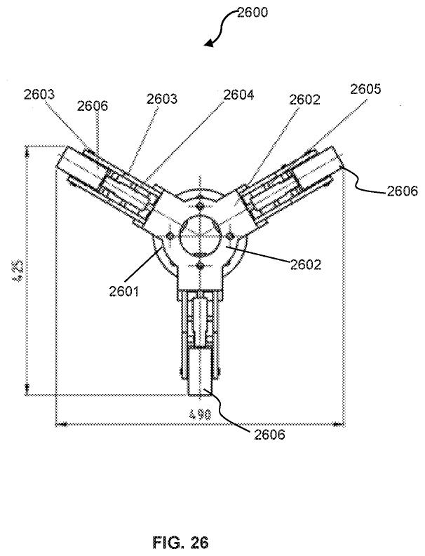

Referring now to FIG. 26, a front structure 2600 of a Y-shaped wheel support assembly in accordance with an exemplary embodiment of the present invention is illustrated. As its name suggests, Y-shaped wheel support assembly 2600 has a Y-shaped arrangement for the caster wheels 2606. Caster wheels 2606 are supported by an outer frame 2603 and a wheel bracket 2604 with a shock absorber 2605. Y-shaped wheel support assembly 2600 has a ring center 2602 where caster wheels 2606 radiate out into a Y-shaped arrangement as shown in FIG. 26. Ring center 2602 is connected to a cardan joint 2601.

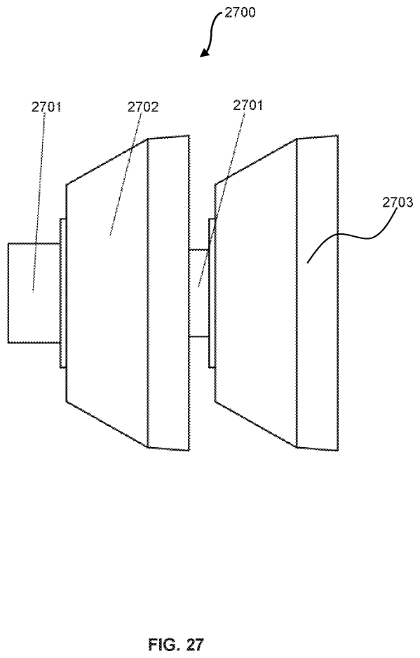

Referring to FIG. 27, a rear buffer block 2700 in accordance with an exemplary embodiment of the present invention is illustrated. Rear buffer block 2700 includes a central axis 2701, a first rear buffer block 2702, and a second rear buffer block 2703. Rear buffer block 2700 is designed to connected wheel assemblies together. Final buffer block 2700 functions to balance the weight and center of gravity between the front section and the rear section.

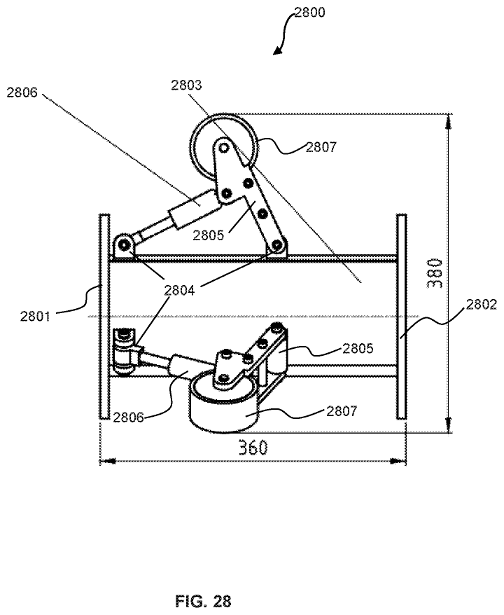

Referring to FIG. 28, a rear wheel assembly 2800 in accordance with an exemplary embodiment of the present invention is illustrated. Central wheel assembly 2800 includes a front board 2801, a rear board 2802, a first base connected to a center tube 2803, a plurality of wheel segments 2810 arranged around the perimeter of centering tube 2803. Each wheel segment 2810 includes rotatable connectors 2804 secured to center tube 2803, a wheel bracket 2805, a shock absorber 2806, and a caster wheel 2807. These elements are connected together as shown in FIG. 28.

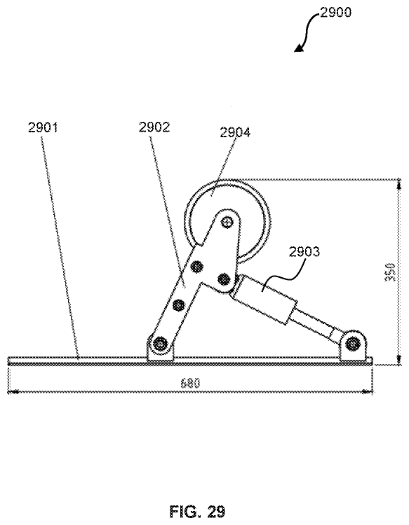

Referring to FIG. 29, a rear wheel 2900 of the central wheel assembly in accordance with an exemplary embodiment of the present invention is illustrated. Wheel set 2900 includes a base 2901, a wheel bracket 2902 connected to a shock absorber 2903, and to a wheel 2904.

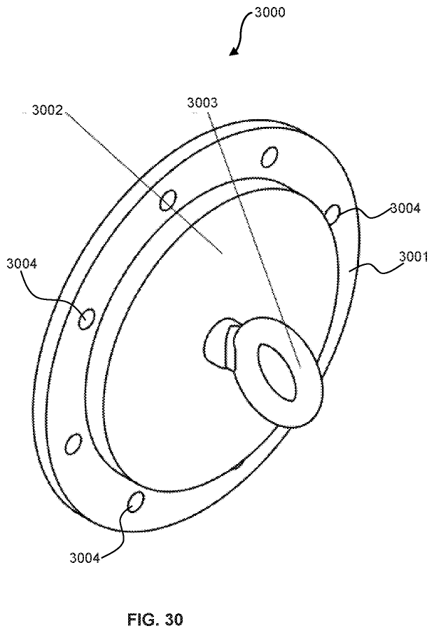

Finally referring to FIG. 30, a rear connector assembly 3000 of the in accordance with an exemplary embodiment of the present invention is illustrated. Rear connector assembly 3000 includes a ring coupler 3002 at the center, an inner section 3003, and an outer section 3001 equipped with screw holes 3004.

### The Efficiency of the Invention

The present invention provides a pipeline inspection gadget (PIG), suitable for detecting defects in steel pipelines. The PIG of the present invention provides the following technical effects including, but not limited to:
The present PIG using a flat Hall sensor with energy saving, high sensitivity and better defect detection capability;
The PIG device being integrated with an Archimedes cam mechanism to predetermine the position of the magnetic yokes relative to the wall of the pipeline to be surveyed to ensure that there is the most suitable distance between the magnetic sensor and the pipe wall, measuring and receiving magnetic flux leakage signals (MFL) while protecting the sensors from damage due to unwanted collisions;
The sensor arm structure being designed with flexibility to ensure that the sensors are sufficiently close to inner circumference walls of the pipelines so that impacts are reduced from collisions with floating defects and/or deposits inside the pipelines;
The magnetic yoke assembly being used appropriately for PIG which is moved by lead screws and two high-precision and stable drums to survey and test with high efficiency.

### REFERENCE NUMERALS

100 magnetic yoke assembly
101 magnetic yoke mounting boards
102 Archimedes cam disc assembly
103 first set steel brushes
104 second set of steel brushes
105 array of magnetic sensors
106 servo motor
201 principal axis
202 protecting tubes
203 first attachment disc
204 second attachment disc
211 driving gear
212 driven gear
300 magnetic yoke sensor mounting plate
311 steel brush mounting base
312 magnetic steel brushes
313 magnetic sensor mounting base
314 magnetic sensor foot
315 finger-shaped magnetic sensor frame (bracket)
316 magnetic sensor container (box)
401 securing screws
501 bracket
502 rotatable screws
510 magnetic sensor box
511 chambers
601 NdFeB N45 magnets
602 steel brush mounting base
701 centre pipe
711 first attachment cam disc
712 second attachment cam disc
810 first clamp set
811 first clamp base
812 first front Archimedes cam disc
813 second front Archimedes cam disc
814 third front Archimedes cam disc
815 first reinforcement clamp
820 second clamp set
821 second clamp base
822 first rear Archimedes cam disc
823 second rear Archimedes cam disc
824 third rear Archimedes cam disc
825 second reinforcement clamp
910 front Archimedes cam disc mechanism
915 first pipe clamp base
912 first front helical groove cam disc
913 second front straight groove cam disc
914 third front helical groove cam disc
915 first pipe clamp base
920 rear Archimedes cam disc mechanism
922 first rear helical groove cam disc
923 second rear straight groove cam disc
924 third rear helical groove cam disc
925 second pipe clamp base
1001 hollow space
1002 concentric rim
1003 concentric rim
1004 concentric rim
1005 attachment plate
1006 clockwise spiral grooves
1007 exterior rim
1100 straight groove cam disc
1101 center through hole
1102 circular rim
1103 straight grooves
1200 counterclockwise (CCW) spiral groove cam disc
1201 center through hole
1202 rim
1203 screw holes
1204 Archimedes CCW spiral grooves
1300 Archimedes clockwise (CW) spiral groove cam disc
1301 center through hole
1302 rim
1303 screw holes
1304 CW spiral Archimedes grooves
1401 center through hole
1402 first segment
1403 holes
1404 gap
1405 outer segment
1406 flexible segment
1407 attachment plates
1501 attachment plate
1502 bearing
1503 bearing
1511 top bracket
1512 screw hole
1520 Archimedes disc cam coupling device
1521 bottom bracket
1522 screw hole
1600 pipeline inspection gadget
1601 front cable coupling assembly
1602 front wheel assembly
1603 first front buffer block
1604 second front buffer block
1605 cardan joint
1607 first rear buffer block
1608 second rear buffer block
1609 rear wheel assembly
1610 rear cable coupling assembly
1700 pipeline inspection gadget (PIG)
1710 front section
1711 ball bearing connector
1712 front wheel assembly
1713 first front buffer block
1714 second front buffer block
1720 cardan joint assembly
1721 front cardan joint wheel assembly
1722 cardan joint
1723 rear cardan joint wheel assembly
1730 rear section
1731 first rear buffer block
1732 second rear buffer block
1733 rear wheel assembly
1734 rear cable coupling assembly
1800 front section of pipeline inspection gadget
1801 front wheel assembly
1802 front cardan joint wheel assembly
1900 front buffer block
1901 center tube
1902 solid rim area
1911 wheel frames
1912 caster wheels
1921 encoder frames
1922 encoder wheels
1923 encoders
2000 rear section of pipeline inspection gadget
2001 center tube (axle)
2005 second cardan joint wheel assembly
2010 first rear buffer block
2011 ball bearing connector
2013 rear wheel assembly
2020 second rear buffer block
2101 center through hole
2102 rim
2103 screw holes
2104 wheel frame
2105 wheels
2111 outer rim
2200 front cable assembly
2201 first base
2202 second base
2203 frame
2211 bolt
2300 encoder wheel assembly
2301 rear base
2302 centre axis
2303 front base
2304 center circular section
2310 caster wheel assembly
2311 caster wheel frame
2312 caster wheel
2320 encoder device
2321 encoder frame
2322 encoder wheel
2323 encoder
2324 encoder handle
2325 absorption member
2400 wheel frame
2401 base
2402 rotatable screw
2403 shock absorber
2404 bracket
2405 handle
2406 wheel axle (shaft)
2407 encoder
2408 wheel
2500 cardan joint wheel assembly
2510 first Y-shaped wheeler connector assembly
2511 first central bracket
2512 leg frame
2513 shock absorber
2514 caster wheel
2521 flexible cardan joint
2530 second Y-shaped wheeler connector assembly
2531 second central bracket
2532 second leg frame
2533 second shock absorber
2534 second caster wheel
2600 front structure of Y-shaped wheeler connector assembly
2601 cardan joint
2602 ring center
2603 outer frame
2604 wheel bracket
2605 shock absorber
2606 caster wheel
2700 buffer block
2701 central axis
2702 first buffer block
2703 second buffer block
2800 central wheel assembly
2801 front board
2802 rear board
2803 center tube
2804 rotatable connector
2805 wheel bracket
2806 shock absorber
2807 caster wheel
2900 wheel set
2901 base
2902 wheel bracket
2903 shock absorber
2904 caster wheel
3000 rear connector assembly
3001 outer section
3002 ring coupler
3003 inner section
3004 holes

1. A magnetic yoke assembly for use in a pipeline inspection gadget (PIG) designed to detect defects in steel pipelines, comprising:
a) an array of magnetic sensors arranged in a circular manner around an center axis and at a predetermined distance close to an inner circumference of said pipeline;
b) an Archimedes cam disc assembly operable to set the position of said array of magnetic sensors with respect to said inner circumference of said steel pipelines at said predetermined distance sufficient to measure the Magnetic Flux Leakage (MFL) signals;
(c) a first array of steel brushes arranged on one side of said array of magnetic sensors;
(d) a second array of steel brushes arranged on the other side of said array of magnetic sensors, wherein said first array of steel brushes and said second array of steel brushes further comprise magnets that generate said MFL signals; and
(e) a servo motor electrically coupled to move said Archimedes cam disc assembly which, in turn, sets said array of magnetic sensors at said predetermined distance with respect to said inner circumference of said pipeline.

2. The yoke assembly according to claim 1, wherein said array of magnetic sensors and said first array of steel brushes and said second array of steel brushes are secured on an array of magnetic yoke mounting boards which is mounted on said Archimedes cam disc assembly around said central axis of said pipeline.

3. The yoke assembly according to claim 2 wherein said array of magnetic sensors further comprises:
a finger-shaped magnetic sensor mounting frame secured to said array of magnetic yoke mounting boards; and
a magnetic sensor container flexibly connected to said finger-shaped magnetic sensor mounting frame, wherein said magnetic sensor container contains magnetic sensors capable of detecting said Magnetic Flux Leakage (MFL) signals reflected from said inner circumference of said pipeline.

4. The yoke assembly according claim 3 wherein said first array of steel brushes and said second array of steel brushes further comprises steel respective brush foundations.

5. The magnetic yoke assembly according to claim 4 wherein said steel brush foundations further comprise said magnets and steel brushes radiating outward toward said inner circumference of said pipeline.

6. The magnetic yoke assembly to claim 5, wherein said steel brushes comprise a plurality of bundles of steel fibers capable of removing deposits on said inner circumference of said pipeline.

7. The magnetic yoke assembly according to claim 6, wherein said magnets are NdFeB N45 type.

8. The magnetic yoke assembly according to claim 7, wherein said Archimedes cam disc assembly further comprises a front set of Archimedes cam discs and a rear set of Archimedes cam discs.

9. The magnetic yoke assembly according to claim 8, wherein said front set of Archimedes cam discs and said rear set of Archimedes cam discs further comprise an Archimedes counterclockwise spiral groove cam disc, an Archimedes straight groove cam disc, and an Archimedes clockwise spiral groove cam disc coupled together.

10. The magnetic yoke assembly according to claim 9, wherein said servo motor further comprises a spur gear mechanically coupled to rotate said Archimedes counterclockwise spiral groove disc and said Archimedes clockwise spiral groove disc while said Archimedes straight groove cam disc is stationary.

11. The magnetic yoke assembly according to claim 9, wherein said magnetic sensors of said array of magnetic sensors are a flat Hall sensor.

12. The yoke assembly according to claim 11 further comprising a plurality of protective tubes mechanically coupled said front set of Archimedes cam discs and said rear set of Archimedes cam discs together.

13. A pipeline inspection gadget (PIG), comprising:
a front connector assembly having a connector operative to connect to a pulling device for pulling said PIG along a pipeline;
a front wheel assembly mechanically coupled to said front connector;
a magnetic yoke assembly, mechanically coupled to said front wheel assembly, operative to detect defects of said pipeline;
a cardan joint assembly, mechanically coupled to said magnetic yoke assembly operative to assist said PIG to move along curvatures of said pipeline;
a rear wheel assembly, mechanically coupled to said cardan joint assembly operable to support said PIG; and
a rear connector assembly, mechanically coupled to said rear wheel assembly, operable to connect said pulling device for pulling said PIG along said pipeline in an opposite direction; wherein said magnetic yoke assembly further comprises:
(a) an array of magnetic sensors arranged in a circular manner around an center axis and at a predetermined distance to an inner circumference of said pipeline;
(b) Archimedes cam disc assembly operable to set said predetermined distance sufficient to measure the Magnetic Flux Leakage (MFL) signals;
(c) a first array of steel brushes arranged on one side of said array of magnetic sensors;
(d) a second array of steel brushes arranged on the other side of said array of magnetic sensors, wherein said first array of steel brushes and said second array of steel brushes are arranged around said inner circumferences of said pipeline; and
(e) a servo motor electrically coupled to move said Archimedes cam disc mechanism which, in turn, sets said array of magnetic sensors at said predetermined distance with respect to said inner circumference of said pipeline.

14. pipeline inspection gadget (PIG) of claim 13 wherein said array of magnetic sensors and said first array of steel brushes and said second array of steel brushes are secured on respective array of magnetic yoke mounting boards.

15. The pipeline inspection gadget (PIG) of claim 14 wherein said array of magnetic sensors further comprises:
a finger-shaped magnetic sensor mounting frame secured to said array of magnetic yoke mounting boards; and
a magnetic sensor container flexibly connected to said finger-shaped magnetic sensor mounting frame, wherein said magnetic sensor container contains magnetic sensors capable of detecting said Magnetic Flux Leakage (MFL) signals reflected from said inner circumference of said pipeline.

16. The pipeline inspection gadget (PIG) of claim 15 wherein said-first array of steel brushes and said second array of steel brushes further comprises steel brush foundations respectively.

17. The pipeline inspection gadget (PIG) of claim 16 wherein said Archimedes cam disc assembly further comprises a front set of Archimedes cam discs and a rear set of Archimedes cam discs.

18. The pipeline inspection gadget (PIG) of claim 17 pipeline inspection gadget (PIG) of claim 17 wherein said front set of Archimedes cam discs and said rear set of Archimedes cam discs further comprise an Archimedes counterclockwise spiral groove cam disc, a Archimedes straight groove cam disc, and an Archimedes clockwise spiral groove cam disc all coupled together.

19. The said servo motor further comprises a spur gear mechanically coupled to rotate said Archimedes counterclockwise spiral groove disc and said Archimedes clockwise spiral groove disc while said Archimedes straight groove cam disc is stationary.

20. The yoke assembly according to 19, wherein said magnetic sensors of said array of magnetic sensors are a flat Hall sensor.
